(19) United States
(12) Patent Application Publication
(10) Pub. No.: US 2025/0111005 A1
(43) Pub. Date: Apr. 3, 2025

(54) REDUCING THE NUMBER OF ROBUST COUNTERPARTS

(71) Applicant: International Business Machines Corporation, Armonk, NY (US)

(72) Inventors: Odellia Alfassi, Giva'at Ela (IL); Evgeny Shindin, Nesher (IL); Roi Ben-Gigi, Tel Aviv (IL)

(21) Appl. No.: 18/477,983

(22) Filed: Sep. 29, 2023

(51) Int. Cl. G06F 17/11

(52) U.S. Cl. CPC G06F 17/11

(57) ABSTRACT

Embodiments of the invention are directed to a computer system for solving an optimization problem having uncertainty. The computer system includes a processor system electronically coupled to a memory. The processor system performs processor system operations that include accessing an initial optimal solution to a nominal version of an uncertain optimization problem; determining an unsatisfied constraint based at least in part on a determination that a robust counterpart of the uncertain constraint is not satisfied for the initial optimal solution; adding variables and constraints associated with the robust counterpart of the uncertain constraint that is not satisfied to the nominal version of the uncertain optimization problem to generate an updated nominal problem; and finding an optimal solution to the updated nominal problem.

### STATEMENT REGARDING PRIOR DISCLOSURES BY THE INVENTOR OR A JOINT INVENTOR

The following disclosure(s) are submitted under 35 U.S.C. 102(b)(1)(A): BONI, et al; EFFICIENT ALGORITHM FOR SOLVING ROBUST COUNTERPARTS OF LP PROBLEMS UNDER BUDGETED UNCERTAINTY; INFORMS 2022; Oct. 16, 2022, pages 1-23.

### BACKGROUND

The present invention relates in general to programmable computers that analyze quantitative models of real-world systems. More specifically, the present invention relates to computing systems, computer-implemented methods, and computer program products that reduce the total number of robust counterpart problems that must be solved to obtain an overall robust solution to an original optimization problem that has data uncertainty. In some embodiments of the invention, the uncertainty originates from uncertain coefficients in the constraints and/or the objective function of the optimization problem.

An optimization problem is the problem of finding the best solution from all feasible solutions. Optimization problems can be quantitatively modeled, and optimization algorithms can be used to determine how the quantitative models can be used to determine the best solutions. The task of translating a “real-world” problem into mathematical equations and variables is generally referred to as formulating an optimization problem. So-called robust counterpart optimization techniques have been developed for dealing with the greater complexity that ordinarily results from solving optimization problems that have data uncertainty.

### SUMMARY

Embodiments of the invention are directed to a computer system for solving an optimization problem having uncertainty. The computer system includes a processor system electronically coupled to a memory. The processor system performs processor system operations that include accessing an initial optimal solution to a nominal version of an uncertain optimization problem; determining an unsatisfied constraint based at least in part on a determination that a robust counterpart of the uncertain constraint is not satisfied for the initial optimal solution; adding variables and constraints associated with the robust counterpart of the uncertain constraint that is not satisfied to the nominal version of the uncertain optimization problem to generate an updated nominal problem; and finding an optimal solution to the updated nominal problem.

Embodiments of the invention are also directed to computer-implemented methods and/or computer program products having substantially the same features and functionality as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a simplified diagram illustrating an example optimization problem that can be solved using aspects of the invention;

FIG. 2B depicts a simplified diagram illustrating an example of uncertainty affecting an optimization problem that can be handled using aspects of the invention;

FIG. 2C depicts a simplified diagram illustrating an example robust counterpart that can be utilized in aspects of the invention;

FIG. 2D depicts an example of a linear reformulation that can be utilized in aspects of the invention;

FIG. 3 depicts a system embodying aspects of the invention;

FIG. 4A depicts a computer-implemented methodology embodying aspects of the invention; and

FIG. 4B depicts a computer-implemented methodology embodying aspects of the invention for uncertain linear problems.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules of the systems illustrated herein are depicted separately for ease of illustration and explanation. In embodiments of the invention, the functions performed by the various components/modules can be distributed differently than shown without departing from the scope of the various embodiments of the invention describe herein unless it is specifically stated otherwise.

Turning now to an overview of technologies that are more specifically related to aspects of the invention, an optimization problem is one in which some function is either maximized or minimized relative to a given set of alternatives. An optimization problem can be organized under three general components, namely, an objective function, decision variables, and constraints. The objective function reflects one or more quantities to be either maximized or minimized. The decision variables, which can be represented as vectors, represent aspects of the problem that the entity formulating the optimization problem has control over. This can include both variables the entity can directly choose, as well as variables that the entity can indirectly influence by the choice of other decision variables. Every decision variable in the optimization problem formulation should either directly influence the objective function, or should influence another decision variable that affects the objective function. Constraints represent any kind of limitation on the values that the decision variables can take. The most intuitive types of constraints are those which directly and obviously limit the choices that can be made. For example, an integrated circuit design has a thermal budget constraint that limits the amount of heat that can be generated when the integrated circuit performs its various tasks.

Linear programming (LP) is a simple technique where complex relationships are depicted through linear functions that can be evaluated or solved to find the optimum points. Although the real relationships might be much more complex, LP can simplify the real relationships to linear relationships. A linear function is a function that represents a straight line on the coordinate plane. For example, y=3x−2 represents a straight line on a coordinate plane and hence it represents a linear function. Because y can be replaced with f (x), this function can be written as f (x)=3x−2. More specifically, LP is a mathematical modeling technique that involves maximizing or minimizing a linear function while taking into account linear constraints. This approach has proven useful for addressing a wide range of applied optimization problems, including, for example, resource allocation, production scheduling, warehousing, layout, transportation scheduling, flight crew scheduling, and the like.

Linear optimization problems can have uncertainty, which means a problem where the coefficients (e.g., the coefficients that appear in the constraints or the objective function, as well as in right hand side free parameters) of a given problem formulation can fall within a set or a range of values rather than having one set nominal value. For example, if a real-world problem includes a constraint that operation A takes 3 hours to complete, data uncertainty is introduced where the constraint is set such that the time to complete operation A is represented as a range of values, for example, between 2.5 and 3.5 hours. So-called robust optimization techniques have been developed for dealing with optimization problems having data uncertainty. In robust optimization, the best solution that is feasible for any realization of the data uncertainty is computed through the solution of corresponding sets of robust counterpart optimization problems. In other words, the way to deal with the various data uncertainty sets/ranges is to find the data values that are most challenging. This is done typically by identifying the values that correspond to the worst case scenario per constraint. These values can depend on the value of the (unknown yet) decision variables. Therefore, robust optimization entails two levels of optimization to deal with—first, for each constraint, finding parameters values that are most challenging (robust counterpart); and then, finding the decision variables values optimizing the entire problem for those parameters. Thus, known robust counterpart techniques generate many individual instances of robust counterpart problems that must be solved, and the resulting overall robust counterpart optimization problem is much bigger and more difficult to solve than its corresponding original (nominal) problem. In some cases this two levels problem can be reformulated as a one-level problem, typically with additional decision variables and constraints. The relatively large size of known robust counterpart reformulations are generally accepted as the price that must be paid to achieve a robust solution.

Turning now to an overview of aspects of the invention, embodiments of the invention provide computing systems, computer-implemented methods, and computer program products that implement novel algorithms that reduce the total number of robust counterpart problems that must be solved to obtain an overall robust solution to an original optimization problem having data uncertainty (e.g., the data uncertainty range to complete operation A is between 2.5 and 3.5 hours). In some embodiments of the invention, the data uncertainty originates from uncertain coefficients in the constraints and/or the objective function of the optimization problem. In accordance with aspects of the invention, the novel algorithm is referred to herein as a robust counterpart computation (RCC) reduction algorithm or module. The RCC reduction algorithms is operable to reduce computations by not automatically replacing each constraint with its corresponding robust counterpart. Instead, the RCC reduction algorithms is operable to identify the constraints of the optimization problem that need to be replaced by a robust counterpart. Embodiments of the invention leverage a discovery by the present inventors that not every uncertain constraint defined for the original optimization problem needs to be replaced by its robust counterpart to obtain a robust solution. By identifying the constraints where a robust counterpart is not needed, the RCC reduction algorithm can remove such robust counterparts from the overall robust counterpart reformulation, thereby reducing the total number of robust counterpart problems that must be solved to obtain the overall robust solution to the original optimization problem.

The computing systems, computer-implemented methods, and computer program products that implement embodiments of the invention can be embodied in a liner problem solver (LPS) system having a nominal optimization problem solver (OPS) and a novel robust counterpart problem solver (RCPS). The OPS receives OPS decision variables and OPS constraints for an objective function (or functions) associated with a quantitative model of a real world system. A real world optimization problem associated with the real world system has been translated (or formulated) into mathematical equations and/or inequalities and variables represented by the OPS decision variables, the OPS constraints, and the OPS objective function (or functions). The RCPS includes a second LPS electronically coupled to a RCC reduction algorithm/module. It receives information of the uncertainty affecting the optimization problem's parameters.

Referring again to known approaches to generating robust counterparts, there is a robust counterpart per constraint, and there is a robust counterpart for the whole optimization problem. Known approaches to generating robust counterparts build the robust counterpart for the whole optimization problem by replacing each nominal constraint within the range of uncertain constraints with its robust counterpart. But computing robust counterparts for all of the nominal constraints within the range of uncertain constraints generates a robust counterpart to the whole problem that can be very large and much larger than the original optimization problem. In embodiments of the invention, the LPS and the RCC reduction algorithm work in tandem to build the robust counterpart for the whole optimization problem by greedily selecting the nominal constraints within the range of uncertain constraints that need to be replaced with its robust counterpart. The LPS and the RCC reduction algorithm perform multiple iterations in which each iteration replaces a nominal constraint within the range of uncertain constraints with its robust counterpart only once and only when needed (i.e., greedily), and the result will be that the robust counterpart for the whole problem will be much smaller than if a non-greedy approach were used.

In a non-limiting example operation of the LPS system, the nominal OPS solves a nominal instance (i.e., with no data uncertainty) of the problem and provides that nominal optimal solution to the RCPS, and more specifically provides that nominal solution to the RCC reduction algorithm/module. The RCC reduction algorithm/module checks each nominal constraint within the range of uncertain constraints and see if its robust counterpart is not satisfied by the solution. If no such constraint is identified, it can be concluded that the nominal solution generated by the OPS is actually an optimal robust solution because it satisfies robust counterparts of all uncertain constraints. However, if the RCC reduction algorithm/module finds that the solution currently under evaluation does not satisfy a certain constraint within the range of uncertain constraints, then the RCC reduction algorithm greedily replaces that certain nominal constraint with its robust counterpart. By “greedily,” it is meant that the replacement is done only for a single violated constraint. In general, a greedy algorithm is an approach for solving a problem by selecting the best option available at the moment. It doesn't worry whether the current best result will bring the overall optimal result. The greedily selected robust counterpart has a reformulation with the same look and feel as a nominal problem. Thus, the greedily selected robust counterpart is added to the problem solved by the OPS, thereby creating an updated problem that is a partially nominal problem in that some of the constraints within the range of uncertain constraints are still nominal and some of the constraints within the range of uncertain constraints are already robust counterparts. This updated problem is provided to the LPS where it is solved, and the new/updated optimal solution is returned to the RCC reduction algorithm to perform another iteration of the previously-described RCC reduction evaluation on the most recent solution generated by the LPS. The iterations of the RCC reduction algorithm and the exchanges between the LPS and the RCC reduction algorithm/module continue until the RCC reduction algorithm/module checks each nominal constraint within the range of uncertain constraints and determines that its robust counterparts are satisfied by the current solution output from the LPS. In accordance with aspects of the invention, this current solution output from the LPS is expected to have fewer robust counterparts for the whole problem than if the previously-described non-greedy approach were used to replace all constraints within the range of uncertain constraints with robust counterparts.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

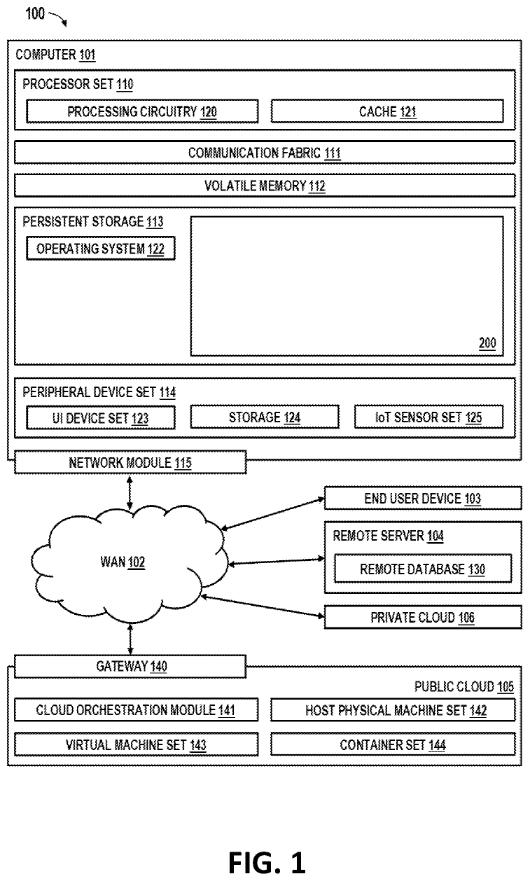

FIG. 1 depicts a computing environment 100 that contains an example of an environment for the execution of at least some of the computer code involved in performing the inventive methods, such as code block 200 operable to implement a robust counterpart computation (RCC) reduction algorithm. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Turning now to a more detailed discussion of aspects of the invention, embodiments of the invention provide computing systems, computer-implemented methods, and computer program products that implement novel algorithms that reduce the total number of robust counterpart problems that must be solved to obtain an overall robust solution to an original optimization problem having data uncertainty ranges (e.g., the data uncertainty range to complete operation A is between 2.5 and 3.5 hours). In some embodiments of the invention, the data uncertainty originates from uncertain coefficients in the constraints and/or the objective function of the optimization problem. In accordance with aspects of the invention, the novel algorithm is referred to herein as a robust counterpart computation (RCC) reduction algorithm or module. The RCC reduction algorithms is operable to reduce computations by not automatically replacing each uncertain constraint with its corresponding robust counterpart. Instead, the RCC reduction algorithms is operable to identify the constraints of the optimization problem that need to be replaced by their robust counterpart. Embodiments of the invention leverage a discovery by the present inventors that not every uncertain constraint defined for the original optimization problem needs to be replaced by its robust counterpart to obtain a robust solution By identifying the constraints where a robust counterpart is not needed, the RCC reduction algorithm can remove such robust counterparts from the overall robust counterpart reformulation, thereby reducing the total number of robust counterpart problems that must be solved to obtain the overall robust solution to the original optimization problem.

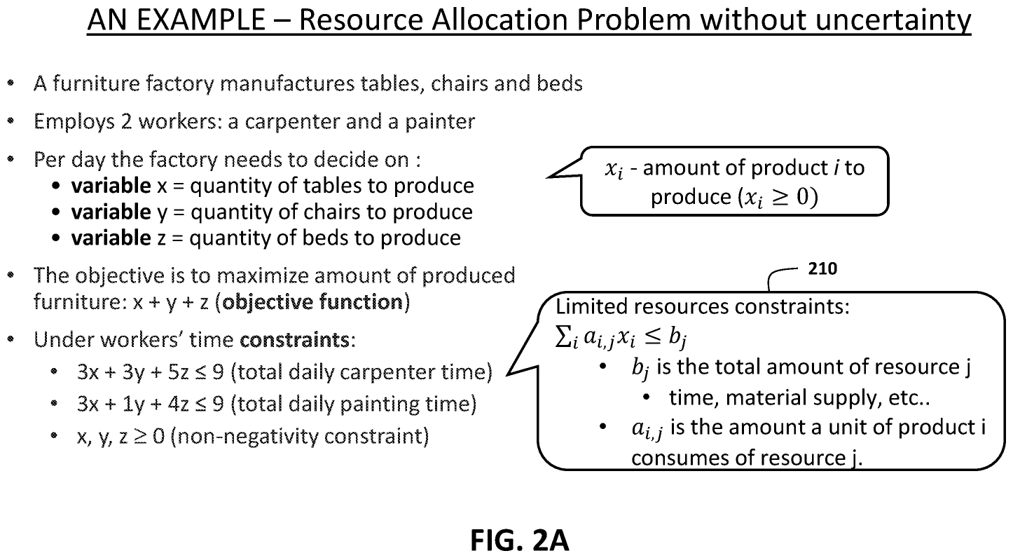

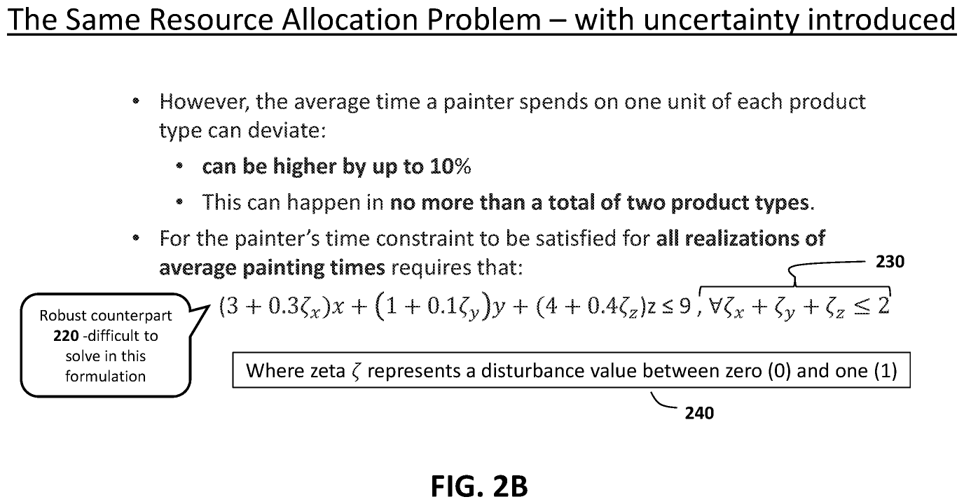

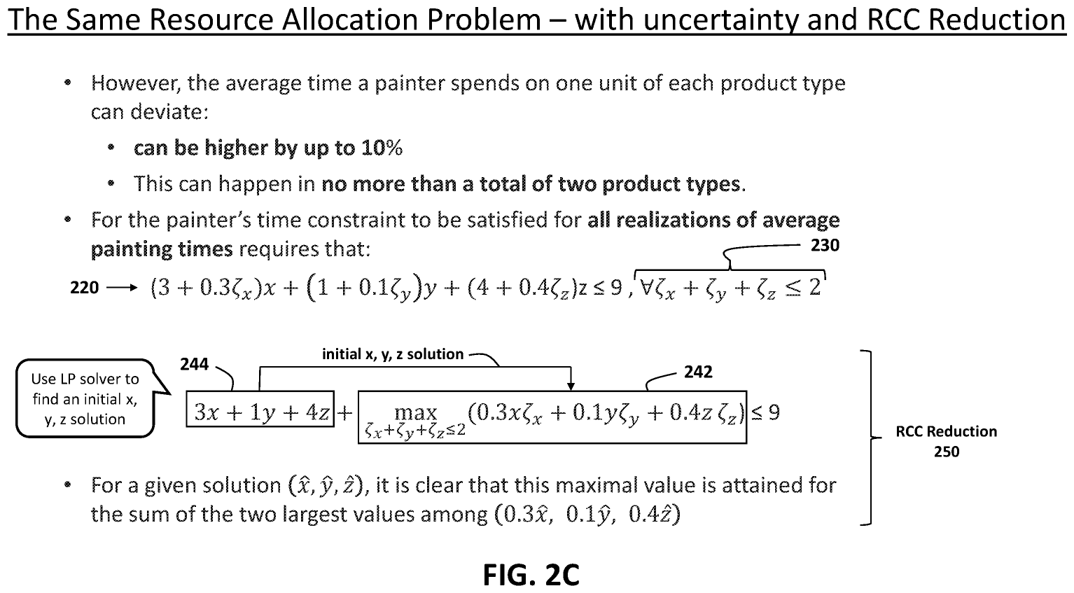

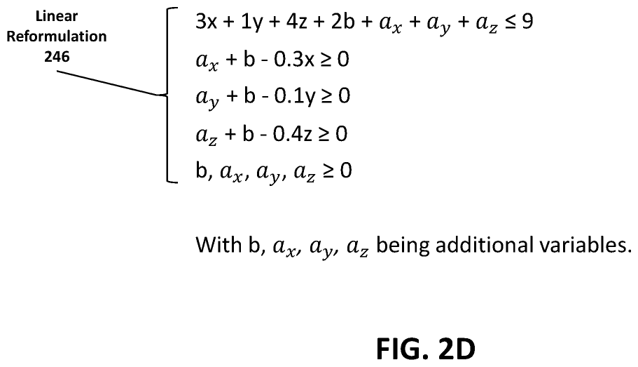

In order to better understand the optimization problem context in which embodiments of the invention operate, a description of optimization problems that can utilize aspects of the invention will now be provided with specific reference to FIGS. 2A-2D. An optimization problem is the problem of finding the best or optimal solution from all feasible solutions. Optimization problems can be quantitatively modeled, and optimization algorithms can be used to determine how the quantitative models can be used to determine the best decisions. The task of translating a “real-world” problem into mathematical equations and variables is generally referred to as formulating an optimization problem.

In general, an optimization problem can be organized under three general components, namely, an objective function, decision variables, and constraints. The objective function reflects one or more quantities to be either maximized or minimized. The decision variables, which can be represented as vectors, represent aspects of the problem that the entity formulating the optimization problem has control over. This can include both variables the entity can directly choose, as well as variables that the entity can indirectly influence by the choice of other decision variables. Every decision variable in the optimization problem formulation should either directly influence the objective function, or should influence another decision variable that affects the objective function. Constraints represent any kind of limitation on the values that the decision variables can take. The most intuitive types of constraints are those which directly and obviously limit the choices that can be made. For example, an integrated circuit design has a thermal budget constraint that limits the amount of heat that can be generated when the integrated circuit performs its various tasks.

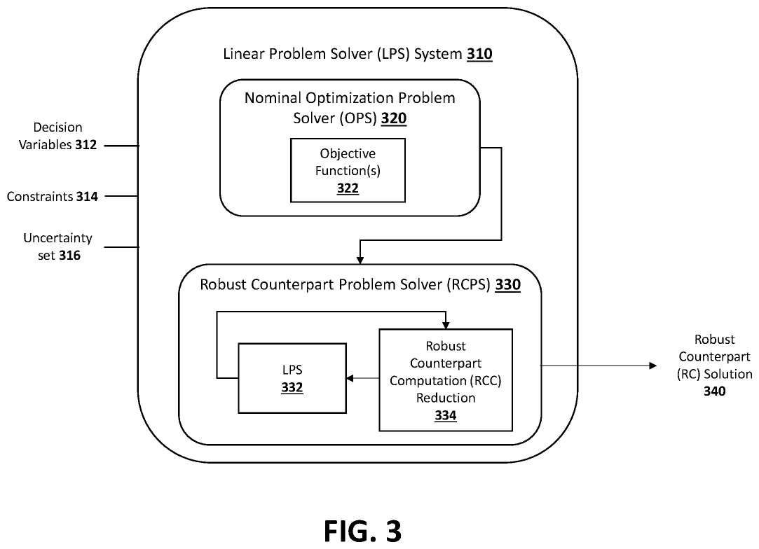

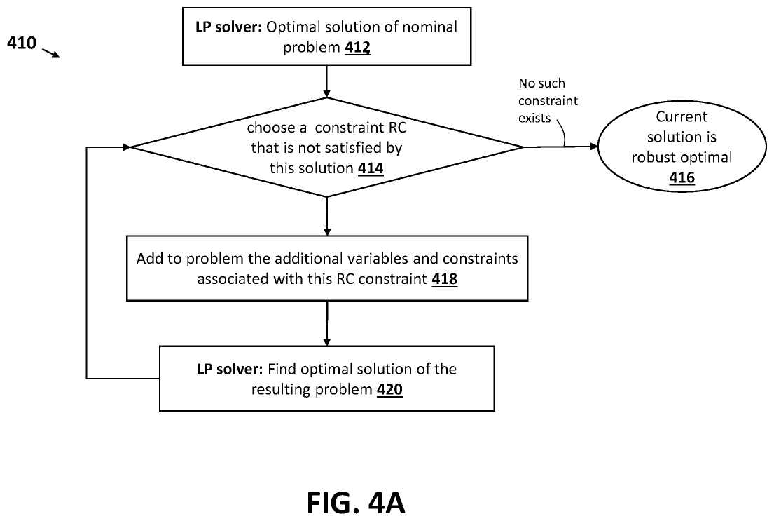

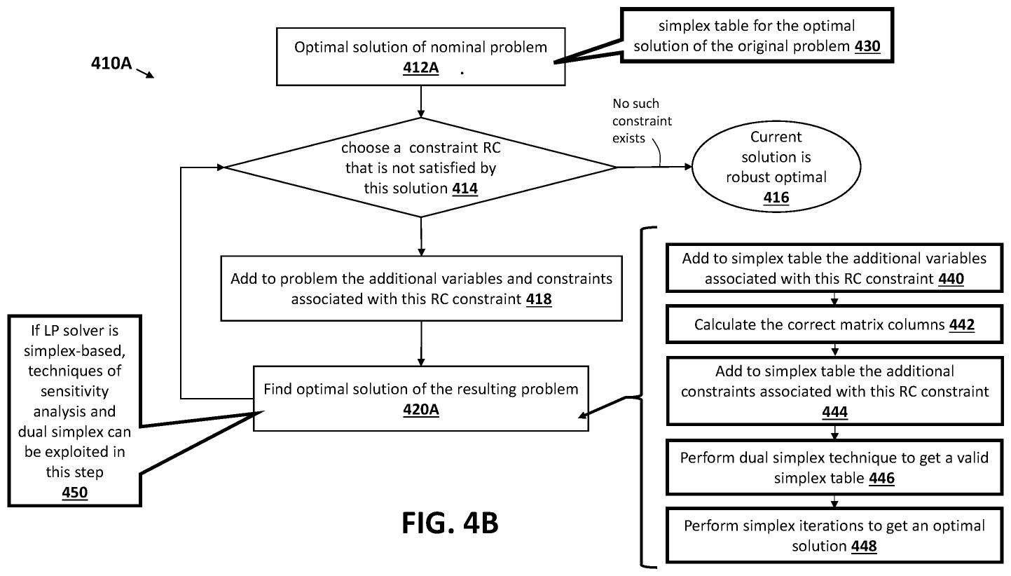

FIGS. 2A-2D depict a non-limiting example of how to set up and solve an optimization problem using embodiments of the invention (e.g., the LPS system 310 shown in FIG. 3; and the methodologies 410, 410A shown in FIGS. 4A and 4B). The optimization problem in FIGS. 2A-2C is a resource allocation problem, and FIG. 2A depicts how the resource allocation can be initially set up as a nominal resource allocation problem without uncertainty. As shown in FIG. 2A, the resource allocation problem is applied to a real-world scenario of a furniture factory that manufactures tables, chairs and beds. The furniture factory employs two workers-a carpenter and a painter. Each day the factory manager needs to decide on a quantity of tables to produce; a quantity of chairs to produce; and a quantity of beds to produce. In formulating the factory manager's production quantity decision as an optimization problem, the to-be-determined (TBD) quantity of tables to produce is set as variable x; the TBD quantity of chairs to produce is set as variable y; and the TBD quantity of beds to produce is set as variable z. The objective function is to maximize the amount of produced furniture. Accordingly, the objective function can be set as x+y+z. The constraints under which the objective function must be maximized are time constraints associated with each worker. As shown in FIG. 2A, the daily total work time for the carpenter is nine (9) hours, and the daily total work time for the painter is also nine (9) hours. Additionally, it takes the carpenter three (3) hours to produce a table; three (3) hours to produce a chair; and five (5) hours to produce a bed. Similarly, it takes the painter three (3) hours to paint a table; one (1) hours to paint a chair; and four (4) hours to paint a bed. Thus, the total daily carpenter time constraint is given by 3x+3y+5z≤9; and the total daily painter time constraint is given by 3x+1y+4z≤9. A non-negativity constraint on the TBD quantities is also provided. The general form of limited resource constraint is given by the block 210 in FIG. 2A. A nominal optimization problem solver (e.g., the nominal OPS 320 shown in FIG. 3) can be used to determine the optimal values of x, y, and z that maximize the optimization function and satisfy the constraints because there is no data uncertainty.

FIG. 2B depicts the resource allocation problem shown in FIG. 2A with data uncertainty introduced. As shown in FIG. 2B, data uncertainty is introduced by taking into account that the average time a painter spends on each product type can deviate. More specifically, for the example depicted in FIG. 2B, the average time a painter spends on one unit of each product can be higher by up to 10 percent; and this time deviation can happen in no more than a total of two (2) product types. To address the above data uncertainty, the nominal constraint on painter's time (3x+1y+4z≤9) should be replaced by the robust counterpart 220 shown in FIG. 2B, where zeta (ζ) represents a vector of disturbances' values between zero (0) and one (1). (shown at block 240 of FIG. 2B). Taking zeta-x (ζₓ) as an example, the nominal value of three (3) is achieved when there is no disturbance and zeta-x is zero (0); and the maximum value of 3.3 is achieved when the disturbance zeta-x is at its maximum value of one (1). The values of zeta-x between zero (0) and one (1) give all the possible coefficient/parameter values. This same analysis applies to zeta-y and zeta-z. The uncertainty constraint that limits the time deviation so that it can happen in no more than a total of two (2) product types is represented by the equation shown at 230 in FIG. 2B.

FIG. 2C depicts the resource allocation problem shown in FIG. 2B with data uncertainty introduced and with RCC reduction operations 250 introduced in accordance with aspects of the invention introduced. More specifically, the RCC reduction operations 250 are non-limiting example of how portions of computer-implemented methodologies 410, 410A (shown in FIGS. 4A and 4B) can be implemented. In order to ensure that constraint 220 is satisfied for every possible value of disturbances (described in blocks 230 and 240), it suffices to find the disturbances values that represent the worst case scenario. Namely, the disturbances that cause the painter to spend the longest additional time on the furniture given the production plan. This is formulated in the optimization problem 242. It is clear that the optimal value for the optimization problem 242 is the sum of two largest values from (0.3x, 0.1y, 0.4z). Thus, calculating this optimal value for a specific set of decision variables values is quite straightforward. For example, for the set (x=2, y=2, z=1), the optimal value of the optimization problem 242 is the sum of the two (2) largest values in (0.3x2, 0.1x2, 0.4x1), which is equal to 0.6+0.4=1.

However, it is not easy to find a closed form of the optimal value of the optimization problem 242 (e.g., a function of the unknown decision variables (x, y, z) and replace the optimization problem 242 with it. Instead, there exists a way to reformulate the robust counterpart 220 as a set of linear constraints on x, y, z and some additional non-negative variables, which is shown as the linear reformulation 246 in FIG. 2D. Thus, when building a robust counterpart for the resource allocation problem, the single nominal constraint with three (3) variables is replaced by a set of four (4) constraints involving seven (7) non-negative variables.

Additional details of the RCC reduction operations 250 will be described in connection with the descriptions of the LPS system 310 and the methodologies 410, 410A provided subsequently herein.

Referring now to FIG. 3, the computing systems, computer-implemented methods, and computer program products that implement embodiments of the invention can be embodied in an LPS system 310 having a nominal OPS 320 and a novel RCPS 330, configured and arranged as shown. The nominal OPS 320 receives OPS decision variables 312 and OPS constraints 314 for an objective function (or functions) 322 associated with a quantitative model of a real world system. A real world optimization problem associated with the real world system has been translated (or formulated) into mathematical equations and/or inequalities and variables represented by the OPS decision variables 312, the OPS constraints 324, and the OPS objective function (or functions) 322. In accordance with some embodiments of the invention, the real world optimization problem is the factory production output problem depicted in FIG. 2A. The RCPS 330 includes a second LPS 332 electronically coupled to a RCC reduction algorithm/module 334 and receives the uncertainty set affecting the problem (as depicted in FIG. 2B) as input. In some embodiments of the invention, the operations performed by the nominal OPS 320 can be configured to perform the operations performed by the second LPS 332.

Referring again to known approaches to generating robust counterparts, there is a robust counterpart per constraint, and there is a robust counterpart for the whole optimization problem. Known approaches to generating robust counterparts build the robust counterpart for the whole optimization problem by replacing each nominal constraint within the range of uncertain constraints with its robust counterpart (e.g. replacing the painter constraint 3x+1y+4z≤9, with the set of constraints 246 in FIG. 2D). But computing robust counterparts for all of the nominal constraints within the range of uncertain constraints generates a robust counterpart to the whole problem that is very large and much larger than the original optimization problem. In embodiments of the invention, the LPS 332 and the RCC reduction algorithm 334 work in tandem to compute the robust solution 340 for the whole optimization problem by greedily selecting the nominal constraints within the range of uncertain constraints that need to be replaced with their robust counterpart. Thus, the LPS 332 and the RCC reduction algorithm 334 perform multiple iterations (e.g., blocks 414, 416, 418, 420 of the methodology 410 shown in FIG. 4A) in which each iteration that generates or identifies a nominal constraint within the range of uncertain constraints that needs to be replaced with its robust counterpart (i.e., greedily), and the result will be that robust counterpart for the whole problem will be much smaller than if a non-greedy approach were used.

In a non-limiting example operation of the LPS system 310, the nominal OPS 320 solves a nominal instance (i.e., with no data uncertainty) of the objective function 322 and provides that nominal solution to the RCPS 330, and more specifically provides the nominal solution to the RCC reduction algorithm/module 334. In FIG. 2C, the output from the OPS 320 is the “initial x, y, z solution” generated for the nominal version 244 of the constraint, which in FIG. 2C is represented by “3x+1y+4z≤9.” The RCC reduction algorithm/module 334 checks each nominal constraint within the range of uncertain constraints and sees if its robust counterpart is not satisfied by the solution. Referring again to FIG. 2C, this can be accomplished by applying the initial x, y, z solution to the robust counterpart (using the RCC reduction operations 250), namely, checking whether for this solution the value of 3x+1y+4z+sum of two largest values from (0.3x, 0.1y, 0.4z) is smaller than or equal to 9. Taking, for example, the solution x=2, y=2, z=0, this value is 3x2+1x2+4x0+ (0.3x2+0.1x2)=8.8≤9, so the robust counterpart is satisfied by this solution. On the other hand, the solution (x=0.2, y=1, z=2) gives a value of 3x0+1x1+4x2+ (0.1x1+0.4x2)=9.8 which is larger than 9, so the robust counterpart is not satisfied by this solution (although it satisfies the nominal constraint).

This operation corresponds to the decision block 414 of the methodology 410 (shown in FIG. 4A). If no such constraint is identified, it can be concluded that the nominal solution generated by the nominal OPS 320 is actually a robust solution because it satisfies all robust counterparts of uncertain constraints. However, if the RCC reduction algorithm/module 334 finds that the solution currently under evaluation does not satisfy a robust counterpart of certain constraint within the range of uncertain constraints, then the RCC reduction algorithm 334 greedily replaces the certain nominal constraint with its robust counterpart reformulation (e.g., the linear reformulation 246 shown in FIG. 2D). By “greedily,” it is meant that only one constraint is replaced during the iteration. In general, a greedy algorithm is an approach for solving a problem by selecting the best option available at the moment. It doesn't worry whether the current best result will bring the overall optimal result. The greedily selected robust counterpart reformulation has the same look and feel as a nominal problem. Thus, the greedily selected robust counterpart is added to the problem solved by the OPS (e.g., adding a linear reformulation (e.g., linear reformulation 246 shown in FIG. 2D) of the optimization problem 242 to the nominal objective function as shown in FIG. 2C), and the updated problem is a partially nominal problem in that some of the constraints within the range of uncertain constraints are still nominal and some of the constraints within the range of uncertain constraints are already robust counterparts. This updated problem is provided to the LPS 332 where it is solved, and the new/updated solution is returned to the RCC reduction algorithm 334 to perform another iteration of the previously-described RCC reduction evaluation (e.g., RCC reduction operations 250 shown in FIG. 2C) on the most recent solution generated by the LPS 332. The iterations of the RCC reduction algorithm 334 and the exchanges between the LPS 332 and the RCC reduction algorithm/module 334 continue until the RCC reduction algorithm/module 334 checks each nominal constraint within the range of uncertain constraints and determines that its robust counterparts are satisfied by the current solution output from the LPS 332 or no nominal constraints remain. In accordance with aspects of the invention, this current solution output from the LPS 332 is expected to have fewer robust counterparts for the whole problem than if the previously-described non-greedy approach were used to replace all constraints within the range of uncertain constraints with robust counterparts.

The LPS system 310 is provided with various tools and methods to solve linear programming problems, including, for example, the graphical method, the simplex method, or by using tools such as R, open solver, and the like. In some embodiments of the invention, simplex functionality of the LPS system 310 can be leveraged to implement functionality of the RCPS 350 in general, and functionality of the RCC reduction algorithm/module 334 as shown by the methodology 410A, which is shown in FIG. 4B and described in greater detail subsequently herein. The simplex method is an iterative process to get the feasible optimal solution. In this method, a basic solution is defined, and at each iteration, the base and values of the variables included in the basic solution (all other variables are equal to zero) keeps transforming to obtain the optimal value for the objective function. The algorithm for a simplex method to solve LPs can be organized around eight (8) steps described as follows. In Step 1, establish or access a given problem in the form of inequality constraints and objective function. In Step 2, convert the given inequalities to equations by adding the slack variable to each inequality expression. In Step 3, create the initial simplex table; write the objective function at the bottom row, where each inequality constraint appears in its own row. This allows the problem to be represented in the form of an augmented matrix, which is called the initial simplex table. In Step 4, the greatest negative entry in the bottom row is identified, which helps to identify the pivot column. The greatest negative entry in the bottom row defines the largest coefficient in the objective function, which will help to increase the value of the objective function as fast as possible. In Step 5, the quotients are computed. To calculate the quotient, the entries in the far right column are divided by the entries in the first column, excluding the bottom row. The smallest quotient identifies the row. The row identified in this step and the element identified in the step will be taken as the pivot element. In Step 6, pivoting is carried out to make all other entries in column zero (0). In Step 7, if there are no negative entries in the bottom row, end the process. Otherwise, start from Step 4. In Step 8, the solution associated with the final simplex table is determined.

FIGS. 4A and 4B illustrate computer-implemented methodologies 410 and 410A that can be implemented using the LPS system 310 (shown in FIG. 3) in general, and by using the RCPS 330 (shown in FIG. 3) in particular. In accordance with aspects of the invention, the methodology 410 represents a more general implementation of aspects of the invention, and the methodology 410A represents an implementation of aspects of the invention that leverages simplex functionality that can be present in implementations of the LPS system 310. As shown in FIG. 4A, the methodology 410 begins at block 412 where the LPS system 310 uses the OPS 320 to generate an initial or nominal solution (e.g., the “initial x, y, z solution” shown in FIG. 2C) to the objective function 322 assuming there is no data uncertainty. At decision block 414, the methodology 410 chooses a constraint whose robust counterpart is not satisfied by the nominal solution. The determination that the robust counterpart of a selected constraint is not satisfied by the nominal solution can be determined in any suitable way, including for example, the previously-described RCC reduction operations 250 shown in FIG. 2C). If at decision block 414, the methodology 410 does not find a constraint where its robust counterpart is not being satisfied (or that no uncertain constraints remain), the methodology 410 concludes that no such constraint exists, and the methodology 410 moves to block 416 and determines that the current solution generated by the OPS 320 is robust and optimal. If at decision block 414, the methodology 410 finds a constraint where its robust counterpart is not being satisfied, the methodology 410 concludes that the current solution generated by the OPS 320 is not robust, then moves to block 418 to look for another solution. At block 418, the methodology 410 adds to the problem solved by the OPS 320 the additional variables and the additional constraints that arise from the reformulation this specific violated robust counterpart only (e.g., block 246 in FIG. 2D). The methodology 410 then moves to block 420 and solves the new problem (e.g., using the LPS 332 shown in FIG. 3). From block 420, the methodology 410 returns to decision block 414 to perform another iteration of the evaluation at decision block 414.

As previously noted, the methodology 410 shown in FIG. 4A represents a more general implementation of aspects of the invention, and the methodology 410A shown in FIG. 4B represents an implementation of aspects of the invention that leverages simplex functionality of the LPS system 310. As shown in FIG. 4B, the methodology 410A is substantially the same as the methodology 410 except in the methodology 410A blocks 412A and 420A are annotated with additional details of how simplex functionality of the LPS system 310 can be utilized to implement the methodology 410. In general, the simplex algorithm of the LPS system 310 is an algorithm that has a table and provides multiple techniques for analyzing linear problems more efficiently using tables. The simplex/table techniques are used in the methodology 410A so that when the additional variables and the additional constraints are added to the nominal problem, there is no need to start solving the updated problem from scratch (building a new initial simplex table). Instead, the additional variables and the additional constraints are added to the latest simplex table using the simplex techniques, and in this way, the number of simplex iterations needed to reach an optimal solution may be reduced. Block 420A leverages the fact that a solution has already been calculated at blocks 412A and 430 using the simplex table.

Thus, in the methodology 410A shown in FIG. 4B, at block 412A, the optimal solution of the nominal problem is determined using the simplex table as described at block 430. Additionally, at block 420A, if the LPS system 310 is simplex-based, techniques of sensitivity analysis and dual simplex analysis can be exploited at block 420A as described at block 450. In general, a simplex method starts with a non-optimal but feasible solution whereas a dual simplex method starts with an optimal but infeasible solution. A simplex method maintains the feasibility during successive iterations whereas a dual simplex method maintains the optimality during successive iterations. Blocks 440-448 describe the simplex-based operations that can be performed by the methodology 410A using simplex techniques of the LPS system 310. More specifically, at block 440, the methodology 410A adds to the simplex table the additional variables associated with this reformulated robust counterpart. At block 442, the methodology 410A calculates the correct matrix columns. At block 444, the methodology 410A adds to the simplex table the additional constraints associated with this reformulated robust counterpart. At block 446, the methodology 410A performs a dual simplex technique to obtain a valid simplex table. At block 448, the methodology 410A performs simplex iterations to obtain an optimal solution. An optimal solution is obtained if all right-hand-side (RHS) values are non-negative (called, the feasibility condition) and if all elements of the last row (i.e., the Cⱼ row) are non-positive (called the optimality condition).

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer system for solving an optimization problem having uncertainty, the computer system comprising a processor system electronically coupled to a memory, wherein the processor system performs processor system operations comprising:
accessing an initial optimal solution to a nominal version of an uncertain optimization problem;
determining an unsatisfied constraint based at least in part on a determination that a robust counterpart of the uncertain constraint is not satisfied for the initial optimal solution;
adding variables and constraints associated with the robust counterpart of the uncertain constraint that is not satisfied to the nominal version of the uncertain optimization problem to generate an updated nominal problem; and
finding an optimal solution to the updated nominal problem.

2. The computer system of claim 1, wherein the processor system operations further comprise performing one or more additional iterations of the processor system operations.

3. The computer system of claim 2, wherein the processor system operations further comprise, during one of the one or more additional iterations of the processor system operations, determining that all robust counterparts of constraints of the updated nominal problem are satisfied for the updated nominal problem.

4. The computer system of claim 3, wherein the processor system operations further comprise, based at least in part on determining that all robust counterparts of constraints of the initial problem are satisfied, further determining that the updated nominal solution is optimal.

5. The computer system of claim 3, wherein:
the computer system for solving the optimization problem having uncertainty comprises a linear problem solver (LPS) system; and
the LPS system comprises an optimization problem solver (OPS) and a robust counterpart problem solver (RCPS).

6. The computer system of claim 5, wherein the RCPS comprises a robust counterpart computation (RCC) reduction algorithm.

7. The computer system of claim 1, wherein the updated nominal problem is generated using a simplex analysis technique.

8. A computer-implemented method for solving an optimization problem having uncertainty, wherein the computer-implemented method performs processor system operations comprising:
accessing an initial optimal solution to a nominal version an uncertain optimization problem;
determining an unsatisfied constraint based at least in part on a determination that a robust counterpart of the uncertain constraint is not satisfied for the initial optimal solution;
adding variables and constraints associated with the robust counterpart of the uncertain constraint that is not satisfied to the nominal version of the uncertain optimization problem to generate an updated nominal problem; and
finding an optimal solution to the updated nominal problem.

9. The computer-implemented method of claim 8, wherein the processor system operations further comprise performing one or more additional iterations of the processor system operations.

10. The computer-implemented method of claim 9, wherein the processor system operations further comprise, during one of the one or more additional iterations of the processor system operations, determining that all robust counterparts of constraints of the updated nominal problem are satisfied for the updated nominal problem.

11. The computer-implemented method of claim 10, wherein the processor system operations further comprise, based at least in part on determining that all robust counterparts of constraints of the initial problem are satisfied, further determining that the updated nominal solution is optimal.

12. The computer-implemented method of claim 10, wherein:
the computer-implemented method for solving the optimization problem having uncertainty comprises using a linear problem solver (LPS) system; and
the LPS system comprises an optimization problem solver (OPS) and a robust counterpart problem solver (RCPS).

13. The computer-implemented method of claim 12, wherein the RCPS comprises a robust counterpart computation (RCC) reduction algorithm.

14. The computer-implemented method of claim 8, wherein the updated nominal problem is generated using a simplex analysis technique.

15. A computer program product for solving an optimization problem having uncertainty, wherein the computer program product comprises a computer readable program stored on a computer readable storage medium, wherein the computer readable program, when executed on a processor system, causes the processor system to perform processor system operations comprising:
accessing an initial optimal solution to a nominal version of an uncertain optimization problem;
determining an unsatisfied constraint based at least in part on a determination that a robust counterpart of the uncertain constraint is not satisfied for the initial optimal solution;
adding variables and constraints associated with the robust counterpart of the uncertain constraint that is not satisfied to the nominal version of the uncertain optimization problem to generate an updated nominal problem; and
finding an optimal solution to the updated nominal problem.

16. The computer program product of claim 15, wherein the processor system operations further comprise performing one or more additional iterations of the processor system operations.

17. The computer program product of claim 16, wherein the processor system operations further comprise, during one of the one or more additional iterations of the processor system operations, determining that all robust counterparts of constraints of the updated nominal problem are satisfied for the updated nominal problem.

18. The computer program product of claim 17, wherein the processor system operations further comprise, based at least in part on determining that all robust counterparts of constraints of the initial problem are satisfied, further determining that the updated nominal solution is optimal.

19. The computer program product of claim 17, wherein:
the processor system comprises a linear problem solver (LPS) system;
the LPS system comprises an optimization problem solver (OPS) and a robust counterpart problem solver (RCPS); and
the RCPS comprises a robust counterpart computation (RCC) reduction algorithm.

20. The computer program product of claim 15, wherein the updated nominal problem is generated using a simplex analysis technique.
